(19) United States
(12) Patent Application Publication
(10) Pub. No.: US 2020/0037636 A1
(43) Pub. Date: Feb. 6, 2020

(54) BEVERAGE CONTAINING LACTIC ACID BACTERIUM POWDER AND HIGH-INTENSITY SWEETENER, METHOD FOR PRODUCING SAID BEVERAGE, METHOD FOR IMPROVING FLAVOR OF SAID BEVERAGE, AND FLAVOR IMPROVING AGENT FOR SAID BEVERAGE

(71) Applicants: Asahi Soft Drinks Co., Ltd., Sumida-ku, Tokyo (JP); Asahi Group Holdings, Ltd., Sumida-ku, Tokyo (JP)

(72) Inventors: Keiichi MATSUURA, Kanagawa (JP); Kazumichi SATO, Kanagawa (JP)

(73) Assignees: Asahi Soft Drinks Co., Ltd., Sumida-ku, Tokyo (JP); Asahi Group Holdings, Ltd., Sumida-ku, Tokyo (JP)

(21) Appl. No.: 16/491,785

(22) PCT Filed: Mar. 15, 2017
(86) PCT No.: PCT/JP2018/009918

§ 371 Date: Sep. 6, 2019

(30) Foreign Application Priority Data
Mar. 15, 2017 (JP) 2017-050472

(51) Int. Cl. A23L 2/38; A23L 2/56; A23L 2/60

(52) U.S. Cl. CPC A23L 2/382; A23V 2002/00; A23L 2/60; A23L 2/56

(57) ABSTRACT

The present invention provides means for reducing the culture medium odor of a beverage resulting from lactic acid bacteria while maintaining the clean sensation of the beverage, for a beverage containing a lactic acid bacterium powder and a high-intensity sweetener. The beverage according to the present invention contains a lactic acid bacterium powder, a high-intensity sweetener, 10 to 5000 ppb of nootkatone and 2.5 to 2000 ppb of linalool. It is preferable that the mass ratio of linalool and nootkatone be nootkatone/linalool=1 to 1000.

### TECHNICAL FIELD

The present invention relates to a beverage containing lactic acid bacterium powder, and to a production method, a flavor improving method and a flavor improving agent of such beverage.

### BACKGROUND ART

A large number of beverages containing lactic acid bacterium powder have been developed in order to meet the various health needs and product demands of the consumers. In addition, in response to the increase in health consciousness, a large number of calorie conscious types of beverages exist, and the need for beverages containing lactic acid bacterium powder and using a high-intensity sweetener is further increasing. However, in beverages using lactic acid bacterium powder and a high-intensity sweetener in combination, it has been a long-standing problem that the odor (culture medium odor) of the cultured lactic acid bacterium powder is strongly felt and that it becomes a flavor with no clean sensation.

Patent Literature 1 (JP 2013-233097 A) describes a method for producing yogurt having a good flavor in which the amino acid odor is masked by adjusting the viscosity of the yogurt and adding a yogurt flavor such as a vanilla-based, milk-based or citrus-based essence, in the method for producing yogurt using lactic acid bacteria belonging to genus Lactococcus. However, this literature does not describe a method for masking the culture medium odor for beverages containing lactic acid bacterium powder cultured and recovered in a culture medium. In addition, although a very large number of flavor components are included in the yogurt flavors, no study was made on how the masking effect is realized by focusing on a specific type of flavor and its content (ratio between multiple types of flavor).

Patent Literature 2 (JP 2013-94154 A) describes a lactic acid bacterium beverage having a cool feeling as a thirst-quenching beverage, and in which the flavor of the lactic acid bacterium beverage is improved and the offensive taste and offensive odor resulting from lactic acid bacteria are suppressed, by setting the ratio of the number of bacterial cells of lactic acid bacteria to the content (mass %) of solid-not-fat to a certain ratio, and by containing certain galactomannans. However, in the invention described in this literature, the flavor release tends to be poor, the flavor not sharp, and the clean sensation impaired, since galactomannans such as locust bean gum and guar gum, which are generally used as a food thickener, stabilizer, gelling agent, etc., are added in order to suppress the offensive taste and offensive odor resulting from lactic acid bacteria. In addition, although this literature describes that the flavors used in known lactic acid bacterium beverages may be optionally formulated, whether the above problem can be solved by a specific type of flavor and its content (ratio between multiple types of flavor) is neither described nor suggested.

### CITATION LIST

### Patent Literature

Patent Literature 1: JP 2013-233097 A

Patent Literature 2: JP 2013-94154 A

### SUMMARY OF INVENTION

### Technical Problem

An object of the present invention is to provide means for suppressing (reducing) the culture medium odor of a beverage resulting from lactic acid bacteria while maintaining the clean sensation of the beverage, for a beverage containing lactic acid bacterium powder and a high-intensity sweetener.

In the present invention, the “clean sensation” is a feeling that the aftertaste after drinking disappears quickly, and refers to the sensation that the aftertaste after drinking, including sweetness, bitterness, sourness, umami and saltiness, fades, and is also known as the sharpness of aftertaste. Moreover, the “culture medium odor” is an odor resulting from the culture medium in which lactic acid bacteria are cultured, and refers to a unique flavor that is unpreferable for conventional soft drinks, that tends to be problematic when formulated with a powder of lactic acid bacteria cultured in a culture medium containing, for example, yeast extract, meat extract and peptone, and has miscellaneous tastes such as umami and animal odor.

### Solution to Problem

The present inventors have found that the above problem can be solved by adding to the beverage, nootkatone and linalool, which are flavor components relatively abundant in citrus fruits, combined in specific amounts, which are less than the threshold (Taste threshold) where each unique flavor cannot be felt.

Namely, in a first aspect of the present invention, a beverage comprising a lactic acid bacterium powder, a high-intensity sweetener, 10 to 5000 ppb of nootkatone and 2.5 to 2000 ppb of linalool, is provided.

It is preferable that the mass ratio of linalool and nootkatone be nootkatone/linalool=1 to 1000. It is preferable that the lactic acid bacterium be cultured in a milk-free culture medium. It is preferable that the lactic acid bacterium powder be contained in an amount of 0.005 mass % or more and 0.5 mass % or less. It is preferable that the lactic acid bacterium has a disrupted cell structure. It is preferable that the high-intensity sweetener be one or more high-intensity sweeteners selected from acesulfame potassium, sucralose and aspartame. It is preferable that the sugar content of the beverage be 0.1 to 7.0 Bx. It is preferable that the energy of the beverage be 20 kcal/100 ml or less.

Lactic acid bacterium “cultured in a milk-free medium” is susceptible to cause the problems of feeling the culture medium odor and impairing the clean sensation when formulated in a beverage, but it is impossible or impractical to specifically identify the causative agent and its amount that have such effects on human senses.

In a second aspect of the present invention, a production method comprising a step of mixing a lactic acid bacterium powder, a high-intensity sweetener, 10 to 5000 ppb of nootkatone and 2.5 to 2000 ppb of linalool, is provided.

In a third aspect of the present invention, a method for improving flavor, comprising allowing a beverage to contain a lactic acid bacterium powder, a high-intensity sweetener, 10 to 5000 ppb of nootkatone and 2.5 to 2000 ppb of linalool together, is provided.

In a fourth aspect of the present invention, a flavor improving agent for beverages comprising lactic acid bacterium powder and a high-intensity sweetener, comprising 10 to 5000 ppb nootkatone and 2.5 to 2000 ppb linalool, is provided.

### Advantageous Effects of Invention

The present invention allows to produce a beverage containing lactic acid bacterium powder, which achieves both clean sensation of the beverage and absence of culture medium odor in the beverage resulting from lactic acid bacteria.

### DESCRIPTION OF EMBODIMENTS

—Beverage—

The beverage of the present invention contains at least a lactic acid bacterium powder, a high-intensity sweetener, 10 to 5000 ppb of nootkatone and 2.5 to 2000 ppb of linalool, and may further contain other ingredients as needed.

[A] Ingredients

(1) Lactic Acid Bacterium Powder

Lactic acid bacteria include, in addition to lactic acid bacillus and lactic acid cocci, bifidus bacteria as lactic acid bacteria in a broad sense. The bacterial cells of lactic acid bacteria are not particularly limited as long as they are generally used in food and drink, and examples thereof include bacterial cells of lactic acid bacteria belonging to the genera Lactobacillus, Bifidobacterium, Leuconostoc, Lactococcus, Pediococcus, Enterococcus, Streptococcus and Weissella, among which the bacterial cells of lactic acid bacteria belonging to the genus Lactobacillus are preferable. The bacterial cells of these lactic acid bacteria may be used alone or in combination of two or more.

Examples of lactic acid bacteria belonging to the genus Lactobacillus include Lactobacillus amylovorus, Lactobacillus gasseri, Lactobacillus acidophilus, Lactobacillus brevis, Lactobacillus casei, Lactobacillus delbrueckii, Lactobacillus fermentum, Lactobacillus helveticus, Lactobacillus kefir, Lactobacillus paracasei, Lactobacillus plantarum, Lactobacillus bulgaricus, Lactobacillus rhamnosus, Lactobacillus salivarius, Lactobacillus johnsonii, Lactobacillus crispatus and Lactobacillus gallinarum.

The genus Bifidobacterium is also referred to as bifidus bacterium, and examples of such lactic acid bacteria include Bifidobacterium infantis, Bifidobacterium adolescentis, Bifidobacterium breve, Bifidobacterium longum, Bifidobacterium pseudolongum, Bifidobacterium animalis, Bifidobacterium bifidum, Bifidobacterium lactis, Bifidobacterium catenulatum, Bifidobacterium pseudocatenulatum and Bifidobacterium magnum.

Examples of lactic acid bacteria belonging to the genus Leuconostoc include Leuconostoc mesenteroides and Leuconostoc lactis.

Examples of lactic acid bacteria belonging to the genus Lactococcus include Lactococcus lactis, Lactococcus plantarum, Lactococcus raffinolactis and Lactococcus cremoris.

Examples of lactic acid bacteria belonging to the genus Pediococcus include Pediococcus pentosaceus and Pediococcus damnosus.

Examples of lactic acid bacteria belonging to the genus Enterococcus include Enterococcus faecalis, Enterococcus hirae and Enterococcus faecium.

Examples of lactic acid bacteria belonging to the genus Streptococcus include Streptococcus thermophilus, Streptococcus lactis, Streptococcus diacetylactis and Streptococcus faecalis.

Examples of lactic acid bacteria belonging to the genus Weissella include Weissella cibaria, Weissella confusa, Weissella halotolerans, Weissella hellenica, Weissella kandleri, Weissella kimchii, Weissella koreensis, Weissella minor, Weissella paramesenteroides, Weissella soli, Weissella thailandensis and Weissella viridescens.

The strains belonging to the above lactic acid bacteria species used in the beverage of the present invention may be either a natural isolate, a deposited strain, a stock strain, a commercially available strain or the like.

The lactic acid bacteria used in the beverage of the present invention, preferably lactic acid bacteria belonging to the genus Lactobacillus, can be proliferated and recovered by culturing under commonly used conditions using a medium commonly used for the culture of lactic acid bacteria.

The culture medium usually contains a carbon source, a nitrogen source, inorganic salts and the like, and any natural medium or synthetic medium may be used as long as it can efficiently culture the above bacterial species. As a carbon source, for example, lactose, glucose, sucrose, fructose, galactose, waste molasses, etc. can be used, and as a nitrogen source, for example, organic nitrogen-containing substances such as casein hydrolysate, whey protein hydrolysate, soybean protein hydrolysate, yeast extracts and meat extracts can be used. Moreover, as inorganic salts, for example, phosphate, sodium, potassium, magnesium, manganese, iron, zinc and the like can be used. Examples of culture media suitable for the culture of lactic acid bacteria include MRS liquid medium, GAM medium, BL medium, Briggs Liver Broth, animal milk, skimmed milk and milk whey. Preferably, sterilized MRS medium can be used. Moreover, when used for food applications, culture media composed only of food materials and food additives are also usable. As a natural medium, tomato juice, carrot juice, other vegetable juices, or apple, pineapple, grape juices and the like can also be used.

The culture is performed under anaerobic conditions at 20° C. to 50° C., preferably 25° C. to 42° C., and more preferably about 37° C. The temperature conditions can be adjusted by a thermostat, a mantle heater, a jacket and the like. Moreover, under anaerobic conditions means under an oxygen environment low enough that bacteria can grow, and anaerobic conditions can be obtained, for example, by using an anaerobic chamber, an anaerobic box or a sealed container or bag containing an oxygen scavenger, or by simply sealing the culture vessel. The forms of culture include static culture, shaking culture, tank culture and the like. In addition, the culture time is not particularly limited, but can be, for example, 3 hours to 96 hours. It is preferable that the pH of the culture medium at the start of culture be maintained, for example, at 4.0 to 8.0.

For example, when using Lactobacillus amylovorus CP1563 strain (accession number FERM BP-11255) as lactic acid bacteria, the lactic acid bacteria can be inoculated in a medium for food grade lactic acid bacteria, and cultured overnight (about 18 hours) at about 37° C.

In the present invention, it is preferable to use lactic acid bacteria cultured in a milk-free culture medium, that is, a culture medium that does not contain animal milk, skimmed milk, milk whey and the like as exemplified above. The action effect of the present invention is preferably exhibited in a beverage containing a powder of lactic acid bacteria cultured in a milk-free culture medium, and is preferable in suppressing yeast odor that tends to be problematic when, for example, a powder of lactic acid bacteria cultured in a medium containing yeast extract is formulated.

(Powder)

The “lactic acid bacterium powder” used in the beverage of the present invention can be obtained by drying a culture solution of lactic acid bacteria into a powder using methods and equipment known in the art. As a specific drying method, there are no particular limitations, but examples thereof include spray drying, drum drying, hot air drying, vacuum drying and freeze drying, and these drying means can be used alone or in combination.

The lactic acid bacterium powder may be a “disrupted lactic acid bacterium powder” in which the bacterial cells are damaged by disrupting the cell structure of the lactic acid bacteria to produce a finer powder than the lactic acid bacterium powder dried simply by a method such as freeze drying. The disrupted lactic acid bacterium powder is obtained by recovering the whole disrupted lactic acid bacteria (that is, essentially all the components that make up the cells) as they are.

The disruption of the lactic acid bacteria can be performed by, for example, treatments of physical crushing, grinding, enzymatic lysis, drug treatment, or autolysis using methods and equipment known in the art.

The physical crushing may be performed using either the wet type (treatment of lactic acid bacteria in a suspension) or the dry type (treatment of lactic acid bacteria as a powder), and the lactic acid bacteria can be damaged by stirring using a homogenizer, a ball mill, a bead mill, a planetary mill or the like, by pressure using a jet mill, a French press, a cell crusher or the like, or by filter filtration.

The enzymatic lysis is performed out by disrupting the cell wall of lactic acid bacteria using an enzyme such as lysozyme, for example.

The drug treatment is performed by disrupting the cell structure of lactic acid bacteria using surfactants such as glycerin fatty acid ester and soybean phospholipid, for example.

The autolysis is performed by lysing lactic acid bacteria with enzymes of the lactic acid bacteria themselves.

Among all of the above treatments, physical crushing is preferable because it does not require adding other reagents or components, and dry physical crushing is more preferable. That is, it is preferable that the lactic acid bacterium powder used in the present invention be one in which the cell structure of the lactic acid bacteria is crushed by physical crushing (physically crushed lactic acid bacterium powder).

More specifically, physical crushing can be performed by a method of treating the lactic acid bacterium powder under the coexistence of various types of balls (for example, 10 mm zirconia balls, 5 mm zirconia balls, 1 mm alumina balls) in a known dry planetary mill cell crusher (such as GOT5 Galaxy 5) at a rotation speed of 50 to 10,000 rpm (for example, 190 rpm) for 30 minutes to 20 hours (for example, 5 hours), or by a method of treating the lactic acid bacterium powder in a known dry jet mill cell crusher (such as Jet-O-Mizer) at a feed rate of 0.01 to 10000 g/min (for example, 0.5 g/min), a discharge pressure of 1 to 1000 kg/cm² (for example 6 kg/cm²), 1 to 10 times (for example, once). In addition, it can also be performed by a method of treating a lactic acid bacterium suspension in a known DYNO-MILL cell crusher (such as DYNO-MILL crusher), using glass beads, at a peripheral speed of 10.0 to 20.0 m/s (for example, about 14.0 m/s), a processing flow rate of 0.1 to 10 L/10 min (for example, about 1 L/10 min), a crushing tank temperature of 10 to 30° C. (for example, about 15° C.), 1 to 7 times (for example, 3 to 5 times), or a method of treating a lactic acid bacterium suspension in a known wet jet mill cell crusher (such as JN20 Nano Jet Pal), at a discharge pressure of 50 to 1000 Mpa (for example, 270 MPa), a processing flow rate of 50 to 1000 ml/min (for example, 300 ml/min), 1 to 30 times (for example, 10 times).

The disrupted lactic acid bacteria obtained by the above methods can be used as it is in the case of a dry treatment, or can be dried to make it into a powdery material in the case of a wet treatment. As a specific drying method, there are no particular limitations, but examples thereof include spray drying, drum drying, hot air drying, vacuum drying and freeze drying, and these drying means can be used alone or in combination.

The amount of lactic acid bacterium powder contained in the beverage of the present invention is not particularly limited, but from the viewpoint of a range within which the action effect of the present invention relating to flavor improvement is easily exhibited and at the same time a physiological activity can be expected, the lower limit value is preferably 0.005 mass %, more preferably 0.01 mass %, and the upper limit value is preferably 0.5 mass %, more preferably 0.1 mass %. A beverage with a small amount of lactic acid bacterium powder (for example, less than the above lower limit of 0.005 mass %) is less likely to have problems such as having the clean sensation of the beverage impaired or having a culture medium odor, and beverages in which such problems are not occurring do not need to be the subject of the present invention.

(2) High-Intensity Sweetener

Examples of high-intensity sweeteners include sucralose, stevia, acesulfame potassium, saccharin sodium, aspartame, glycyrrhizin, dipotassium glycyrrhizinate, thaumatin and neotame, and sucralose, acesulfame potassium and aspartame are preferable, and acesulfame potassium and aspartame are particularly preferable.

(3) Linalool and Nootkatone

Linalool and nootkatone are known compounds as flavor components and are also used as flavors. The linalool and nootkatone contained in the beverage of the present invention may be derived from a purified product such as a flavor, or it may be derived from a natural product such as a fruit juice of citrus fruits and the like formulated in the beverage as an optional ingredient as described later.

The concentration of linalool contained in the beverage of the present invention is 2.5 to 2000 ppb, preferably 2.5 to 1000 ppb, and particularly preferably 2.5 to 500 ppb. At less than 2.5 ppb, it is difficult to obtain the effects of the invention, and if it is more than 2000 ppb, the clean sensation is impaired, which is not preferable.

The concentration of nootkatone contained in the beverage of the present invention is 10 to 5000 ppb, preferably 10 to 4000 ppb, particularly preferably 10 to 3000 ppb, and most preferably 10 to 2000 ppb. At less than 10 ppb, it is difficult to obtain the effects of the invention, and if it is more than 5000 ppb, the clean sensation is impaired, which is not preferable.

Moreover, the mass ratio of linalool and nootkatone (mass of nootkatone to 1 part by mass of linalool, nootkatone/linanool) is preferably 1 to 1000, more preferably 1 to 100, and particularly preferably 1 to 10, as a range within which the effects of the invention can be strongly obtained.

The measuring methods of the above concentrations and mass ratios include using known measuring techniques such as a gas chromatograph mass spectrometer (GC/MS).

Since the linalool and nootkatone used in the present invention exert their effects at an amount smaller than the threshold (Taste threshold), they are preferable in terms of reducing the culture medium odor and providing a clean sensation, without the characteristics of these flavor components being strongly felt.

(4) Water and Other Ingredients

The beverage of the present invention contains water in addition to the above essential ingredients, and within a range not impairing the effects of the present invention, preferably within a range satisfying the conditions such as the defined sugar content, energy and the like, other ingredients (optional ingredients) may be contained as appropriate if necessary. Examples of optional ingredients include milk, milk protein stabilizers, fruit juices, acidulants, sweeteners (except high-intensity sweeteners) and sugar content adjusters.

Water is not particularly limited, and for example, ion exchange water can be used. The content ratio of water in the beverage of the present invention can be adjusted as appropriate while taking into consideration the content of the other ingredients, particularly the concentrations of nootkatone and linalool, the content of lactic acid bacterium powder as described above, the preferable range for sugar content and energy, and the like.

The milk may be any milk of animal or plant origin. For example, animal milk such as cow milk, goat milk, sheep milk and horse milk, and plant milk such as soy milk can be used, and cow milk is common. These milks can be used alone or as a mixture of two or more. Moreover, these milks can also be used as fermented milk fermented using microorganisms, such as lactic acid bacteria and bifidus bacteria. The form of milk is not particularly limited, and examples thereof include whole fat milk, skim milk, whey and milk protein concentrate, and milk reduced from powdered milk or concentrated milk can also be used.

Milk protein stabilizers typically include soybean polysaccharides. Soybean polysaccharides are usually polysaccharides extracted and purified from bean curd (fibrous strained lees) by-produced in the production process of soy products, and those negatively charged under acidity derived from the carboxyl group of the contained galacturonic acid can be used. An example of commercial products include trade name “SM-1200” (manufactured by San-Ei Gen F.F.I.,Inc.).

The content ratio of soybean polysaccharide in the beverage of the present invention can be adjusted as appropriate according to the content ratio of milk etc., but preferably it is 0.01 to 0.5 mass % in the total amount of the beverage.

Milk protein stabilizers also include those other than soybean polysaccharides, such as HM pectin, carboxymethylcellulose (CMC), gellan gum, guar gum, xanthan gum and gum arabic. It is preferable that the content ratio of these milk protein stabilizers be small, and it is more preferable not to include them in the beverage.

Examples of the acidulant include organic acids such as lactic acid, citric acid, malic acid, tartaric acid, acetic acid, phytic acid, gluconic acid, succinic acid and fumaric acid or salts thereof (such as sodium salts), and inorganic acids such as phosphoric acid or salts thereof.

Examples of the fruit juice include fruit juices of citrus fruits such as orange, lemon and grapefruit, and the juices of grapes, peaches, apples, bananas and the like.

When fermented milk, acidulants, fruit juices and the like are used as optional ingredients, it is preferable to adjust the pH of the beverage of the present invention to a suitable range, for example 2.5 to 4.6, depending on those ingredients. The lower limit of pH is preferably 3.0, more preferably 3.5. The upper limit of pH is more preferably 4.0. When the pH is less than 2.5 or more than 4.6, the clean sensation may be impaired.

Examples of the sweetener and sugar content adjuster include saccharides such as sucrose, maltose, fructose, glucose, high-fructose corn syrup and oligosaccharides, sugar alcohols such as erythritol, maltitol and xylitol, and dietary fibers such as indigestible dextrin and agar. The above sweeteners and sugar content adjusters can be contained in the beverage in combination with a high-intensity sweetener, in the range within which the action effect of the present invention relating to flavor improvement and the like are exhibited, or in the range not adversely affecting the action effect of the present invention, and preferably in the range satisfying the conditions of sugar content and energy described later. When the above sweeteners are used as a substitute for all or most of the high-intensity sweeteners, the culture medium odor can be reduced without using the predetermined amounts of linalool and nootkatone which are essential in the present invention. Therefore, the action effect relating to the flavor improvement of the present invention is exhibited in a beverage containing only high-intensity sweeteners and no above-mentioned sweetener (sugar content adjuster), or a beverage containing the above sweeteners and high-intensity sweeteners in appropriate or preferable embodiments as described above.

[B] Sugar Content

The sugar content (Brix value, unit: Bx) of the beverage of the present invention is usually 0.1 to 7.0, and the upper limit is preferably 6.0, more preferably 5.0. When the sugar content is less than 7.0 and nootkatone and linalool are not present, the culture medium odor resulting from the lactic acid bacterium powder is particularly easy to feel.

In the present invention, the sugar content is the reading of a sugar refractometer at 20° C., for example, it means the soluble solid content in the beverage of the present invention measured at 20° C. using a digital refractometer Rx-5000 (manufactured by Atago Co., Ltd.).

[C] Energy

In order to make the beverage of the present invention a low-calorie beverage, it is preferable to adjust the type and content of each raw material and control its energy. It is preferable that the energy of the beverage of the present invention be controlled to 20 kcal/100 ml or less, particularly 5 kcal/100 ml or less. The lower limit is not particularly limited, but is usually 0.1 kcal/100 ml. When the energy is less than 20 kcal/100 ml and nootkatone and linalool are not present, the culture medium odor resulting from the lactic acid bacterium powder is particularly easy to feel.

—Production Method—

The method for producing the beverage of the present invention is a production method for producing the beverage of the present invention having various properties as described above, and comprises a step of mixing a lactic acid bacterium powder, a high-intensity sweetener, 10 to 5000 ppb nootkatone and 2.5 to 2000 ppb linalool (referred to as the “mixing step” in the present description). In other words, the method for producing the beverage containing a lactic acid bacterium powder and a high-intensity sweetener according to the present invention comprises a step of mixing nootkatone and linalool with the lactic acid bacterium powder and the high-intensity sweetener so that their concentrations in the beverage (finished product) be 10 to 5000 ppb and 2.5 to 2000 ppb, respectively. This production method usually further comprises a step of preparing predetermined amounts of the raw materials for the lactic acid bacterium powder, the high-intensity sweetener, 10 to 5000 ppb nootkatone and 2.5 to 2000 ppb linalool, before the mixing step (referred to as the “preparation step” in the present description). The matters relating to the beverage of the present invention as described above can be suitably applied to the method for producing the beverage of the present invention.

In the mixing step, each of the predetermined amounts of raw material that has been prepared may be sequentially or simultaneously added to water and mixed by stirring or the like according to a general method in the art. The method for preparing the lactic acid bacterium powder is as described above in the present description. The high-intensity sweetener, nootkatone and linalool are each available as products. If necessary, nootkatone and linalool may be mixed in a predetermined ratio prior to the mixing step so as to be in a form (composition) like the “flavor improving agent” as described later.

In the present invention, particularly for nootkatone and linalool, it is preferable to prepare them in the preparation step each in the form of a purified product or in the form of a mixture of purified products (flavor improving agent) in order to adjust the concentrations in the beverage to the predetermined range defined in the present invention, then use them in the mixing step.

On the other hand, nootkatone and linalool are relatively abundant in fruit juices (essence oil, water-soluble essence) of citrus fruits such as orange, lemon and grapefruit, and are also contained in other fruit juices. The embodiments in which adding such fruit juice in the mixing step, and if necessary, adding the lacking amount of nootkatone and/or linalool allow that nootkatone and linalool be present in the beverage at the predetermined concentrations defined in the present invention, are also included in the method for producing the beverage of the present invention. For example, it is estimated that grapefruit juice contains about 5 ppm of nootkatone and about 1 ppm of linalool, in which case it is possible to prepare the beverage of the present invention by adding 1 mass % of grapefruit juice to the beverage.

The method for producing the beverage of the present invention may further include other steps as needed and as appropriate in addition to the above steps, as long as it does not impair the effects of the present invention. Examples of other steps include the steps of performing a treatment of sterilization, homogenization and filtration.

The sterilization treatment can be performed, for example, by heat sterilization having a sterilization value equal to or higher than 10 minutes at 65° C. The method of sterilization is not particularly limited, and methods such as conventional plate type sterilization, tubular type sterilization, retort sterilization, batch sterilization and autoclave sterilization can be adopted. In addition, the sterilization treatment can be performed either before or after a homogenization treatment, or both, or either before or after filling the containers, or both.

Methods for making the beverage of the present invention after sterilization a packaged beverage include a method of hot-pack filling the beverage in a container and cooling the filled container, and a method of cooling the beverage to a temperature suitable for filling the container and performing aseptic filling in a container washed and sterilized in advance.

—Flavor Improvement Method—

The method for improving the flavor of the present invention includes the coexistence of the lactic acid bacterium powder, the high-intensity sweetener, 10 to 5000 ppb of nootkatone and 2.5 to 2000 ppb of linalool in the beverage. In other words, the method for improving the flavor of the beverage containing lactic acid bacterium powder and a high-intensity sweetener according to the present invention includes the coexistence of 10 to 5000 ppb of nootkatone and 2.5 to 2000 ppb of linalool in the beverage containing lactic acid bacterium powder and a high-intensity sweetener. In the present invention, “flavor improvement” refers to reducing the culture medium odor of the beverage resulting from lactic acid bacteria while maintaining the clean sensation, compared to a beverage containing a lactic acid bacterium powder and a high-intensity sweetener. The matters relating to the beverage of the present invention as described above and the matters relating to the flavor improving agent of the present invention described later can be suitably applied to the method for improving the flavor of the present invention.

—Flavor Improving Agent—

The flavor improving agent of the present invention is a flavor improving agent for beverages containing lactic acid bacterium powder and a high-intensity sweetener, and is a composition containing 10 to 5000 ppb nootkatone and 2.5 to 2000 ppb linalool. This flavor improving agent can be used to be added to a beverage containing lactic acid bacterium powder and a high-intensity sweetener in such an amount that nootkatone be 10 to 5000 ppb and linalool 2.5 to 2000 ppb. Moreover, it is preferable that the mass ratio of linalool and nootkatone in the flavor improving agent of the present invention be nootkatone/linalool=1 to 1000. Other than this, the preferable amounts (ppb) and preferable mass ratios of linalool and nootkatone contained in the flavor improving agent of the present invention can be those in accordance with the preferable conditions of linalool and nootkatone contained in the beverage of the present invention described above.

### EXAMPLES

### Example 1

### Study of the Flavor Components

A sterilized base beverage having the composition shown in Table 1 and formulated with a lactic acid bacterium powder, a high-intensity sweetener and an acidulant was prepared according to a conventional method. To this base beverage, the flavor components shown in Table 2 such as nootkatone and linalool were added to prepare a test beverage. A flavor evaluation was conducted by five panelists who received specialized training on sensory items such as “culture medium odor” and “clean sensation” for this test beverage (the evaluation value is the average value of the five panelists). The sugar content, acidity, pH, sweetness and energy described as properties are the values determined according to the method described in the present description or other conventional methods.

TABLE 1

| Raw Material | | Amount (w/w %) |
|---|---|---|
| Base Beverage | Acesulfame K | 0.050 |
| | Citric Acid | 0.110 |
| | Lactic Acid | 0.155 |
| | Trisodium Citrate | 0.090 |
| | Lactic Acid Bacterium Powder | 0.050 |
| | (CP1563 Strain Crushed Lactic Acid | |
| | Bacteria)*¹ | |

| | |
|---|---|
| Flavor Component | See Table 2 |
| Properties | |
| Sugar Content | 0.40 |
| Acidity | 0.22 |
| pH | 3.35 |
| Sweetness | 10.0 |
| Energy | 1.6 kcal/100 ml |

*¹Prepared according to “Preparation of CP1563 powder” on page 2 of Nakamura et al. Microbial Ecology in Health & Disease 2016, 27: 30312

The results of Example 1 are shown in Table 2. It can be seen that nootkatone and linalool can each reduce the culture medium odor resulting from lactic acid bacteria to some extent while having a clean sensation, and their effect is enhanced, the clean sensation is further maintained and the culture medium odor resulting from lactic acid bacteria can be further suppressed when nootkatone and linalool are combined.

TABLE 2

| | Flavor Component | | | | | | |
|---|---|---|---|---|---|---|---|
| | | | | | | Nootkatone + | |
| | Nootkatone | Valencene | Linalool | Octanal | Decanal | Linalool | Average |
| Threshold (ppm)*² | 20 | n/a | 5 | 25 | 10 | | |
| Concentration | 100 | 125 | 25 | 125 | 50 | 50 + 12.5 | |
| in Sample | | | | | | | |
| Beverage (ppb)*³ | | | | | | | |
| Ratio to the | 1/200 | — | 1/200 | 1/200 | 1/200 | 1/200 | |
| Threshold Value | | | | | | | |
| Clean sensation*⁴ | 5.6 | 5.4 | 5.8 | 4.8 | 4.2 | 6.6 | 5.4 |
| (8: Have a clean | | | | | | | |
| sensation) | | | | | | | |
| Culture Medium | 2.8 | 2.8 | 1.6 | 1.4 | 1.6 | 1.4 | 1.9 |
| Odor*⁴ | | | | | | | |
| (0: No culture | | | | | | | |
| medium odor) | | | | | | | |
| Overall Flavor*⁴ | 5.2 | 5.4 | 5.6 | 5.4 | 4.0 | 6.2 | 5.3 |
| (8: Good) | | | | | | | |

*²Literature values (taste threshold values of Flavor Ingredients 6th edition)
*³Calculated value based on the mass of the base beverage and the mass of flavor components added to it
*⁴Score set to “4” for cases similar to the control product (base beverage) to which no flavor component is added

### Example 2

### Study of the Optimum Concentration of Nootkatone and Linalool

A sterilized base beverage having the composition shown in Table 3 and formulated with a lactic acid bacterium powder, a high-intensity sweetener and an acidulant was prepared according to a conventional method. To this base beverage, flavor components, in which the mass ratios of nootkatone and linalool were changed as shown in Table 4, were added, and after preparing the test beverage, a sensory test of flavor evaluation was conducted similarly as in Example 1.

TABLE 3

| Raw Material | | Amount (w/w %) |
|---|---|---|
| Base Beverage | Acesulfame K | 0.050 |
| | Citric Acid | 0.110 |
| | Lactic Acid | 0.155 |
| | Trisodium Citrate | 0.090 |
| | Lactic Acid Bacterium Powder | 0.050 |
| | (CP1563 Strain Crushed Lactic Acid | |
| | Bacteria)*¹ | |

| | |
|---|---|
| Flavor Component | See Table 4 |
| Properties | |
| Sugar Content | 0.40 |
| Acidity | 0.22 |
| pH | 3.35 |
| Sweetness | 10.0 |
| Energy | 1.6 kcal/100 ml |

*¹Prepared according to “Preparation of CP1563 powder” on page 2 of Nakamura et al. Microbial Ecology in Health & Disease 2016, 27: 30312

The results of Example 2 are shown in Table 4. From the viewpoint of achieving both effects of maintaining the clean sensation and suppressing the culture medium odor resulting from lactic acid bacteria, it can be seen that it is effective when the concentration of nootkatone is 10 to 5000 ppb, and the concentration of linalool is in the range of 2.5 to 2000 ppb, and that it is preferable that the mass ratio of nootkatone/linalool be in the range of 1 to 1000.

TABLE 4

| | Flavor Component | | | | | | | | | |
|---|---|---|---|---|---|---|---|---|---|---|
| | Level | Level | Level | Level | Level | Level | Level | Level | Level | |
| | 1 | 2 | 3 | 4 | 5 | 6 | 7 | 8 | 9 | Average |
| Nootkatone (ppb)*³ | 1 | 10 | 100 | 1000 | 1000 | 1000 | 1000 | 10000 | 10000 | |
| Linalool (ppb)*³ | 0.25 | 2.5 | 25 | 250 | 1 | 10 | 1000 | 10000 | 2500 | |
| Mass Ratio | 4 | 4 | 4 | 4 | 1000 | 10 | 1 | 1 | 4 | |
| (Nootkatone/ | | | | | | | | | | |
| Linalool) | | | | | | | | | | |
| Clean sensation*⁴ | 4.6 | 5.0 | 6.2 | 6.4 | 6.0 | 5.8 | 6.0 | 3.6 | 4.0 | 5.3 |
| (8: Have a clean | | | | | | | | | | |
| sensation) | | | | | | | | | | |
| Culture Medium | 4.2 | 3.6 | 3.2 | 1.8 | 2.0 | 2.4 | 2.0 | 1.0 | 1.0 | 1.7 |
| Odor*⁴ | | | | | | | | | | |
| (0: No culture | | | | | | | | | | |
| medium odor) | | | | | | | | | | |

*³Calculated value based on the mass of the base beverage and the mass of flavor components added to it
*⁴Score set to “4” for cases similar to the control product to which no flavor component is added

### Example 3

### Study of the Amount of Lactic Acid Bacterium Powder

A test beverage having the composition shown in Table 5 and formulated with a lactic acid bacterium powder, a high-intensity sweetener, an acidulant, nootkatone and linalool was prepared according to a conventional method. The formulated amount of the lactic acid bacterium powder was changed as shown in Table 6. Thereafter, a sensory test of flavor evaluation was conducted similarly as in Example 1. It has been confirmed by a preliminary test that problems in the clean sensation and culture medium odor occur when flavor components are not added for beverages with an amount of lactic acid bacterium powder of 0.001 mass % (When the evaluation of the sensory test on the control products containing no lactic acid bacterium powder is set to “4”, the sensory evaluation of the clean sensation and the culture medium odor are 2.8 and 6.4, respectively).

TABLE 5

| Raw Material | Amount (w/w %) |
|---|---|
| Acesulfame K | 0.050 |
| Citric Acid | 0.110 |
| Lactic Acid | 0.155 |
| Trisodium Citrate | 0.090 |
| Lactic Acid Bacterium Powder (CP1563 Strain | See Table 6 |
| Crushed Lactic Acid Bacteria)*¹ | |
| Flavor Component*³ | Nootkatone: 1000 ppb |
| | Linalool: 250 ppb |
| Properties | |
| Sugar Content | 0.40(0.85*⁵) |
| Acidity | 0.22(0.24*⁵) |
| pH | 3.35 |
| Sweetness | 10.0 |
| Energy | 1.6(3.4*⁵) kcal/100 ml |

*¹Prepared according to “Preparation of CP1563 powder” on page 2 of Nakamura et al. Microbial Ecology in Health & Disease 2016, 27: 30312
*³Calculated value based on the mass of added flavor components
*⁵When the amount of lactic acid bacterium powder (Table 6) is 0.5 w/w %

The results of Example 3 are shown in Table 6. It can be seen that the flavor components consisting of nootkatone (1000 ppb) and linalool (250 ppb) exerts a preferable effect in the sensory test for beverages having a lactic acid bacterium powder amount of 0.01 or 0.05 mass %.

TABLE 6

| | Lactic Acid Bacterium Powder | | | | |
|---|---|---|---|---|---|
| | Bacterium | Bacterium | Bacterium | Bacterium | |
| | Powder | Powder | Powder | Powder | |
| | 0.001 w/w % | 0.01 w/w % | 0.05 w/w % | 0.5 w/w % | Average |
| Clean sensation*⁴ | 5.4 | 5.6 | 6.4 | 4.4 | 5.5 |
| (8: Have a clean sensation) | | | | | |
| Culture Medium Odor*⁴ | 2.6 | 2.0 | 1.8 | 3.2 | 2.3 |
| (0: No culture medium odor) | | | | | |

*⁴Score set to “4” for cases similar to the control product to which no flavor component is added

### Example 4

### Study of the High-Intensity Sweetener

A test beverage having the composition shown in Table 7 and formulated with a lactic acid bacterium powder, a high-intensity sweetener, an acidulant, nootkatone and linalool was prepared according to a conventional method. The formulated amount of the high-intensity sweetener was changed as shown in Table 8. Thereafter, a sensory test of flavor evaluation was conducted similarly as in Example 1. Regarding acesulfame K, the data of level 4 of Example 2 is shown again for comparison with other high-intensity sweeteners.

TABLE 7

| Raw Material | Amount (w/w %) |
|---|---|
| High-Intensity Sweetener | See Table 8 |
| Citric Acid | 0.110 |
| Lactic Acid | 0.155 |
| Trisodium Citrate | 0.090 |
| Lactic Acid Bacterium Powder (CP1563 Strain | 0.050 |
| Crushed Lactic Acid Bacteria)*¹ | |
| Flavor Component*³ | Nootkatone: 1000 ppb |
| | Linalool: 250 ppb |
| Properties | |
| Sugar Content | 0.40 |
| Acidity | 0.22 |
| pH | 3.35 |
| Sweetness | 10.0 |
| Energy | 1.6 kcal/100 ml |

*¹Prepared according to “Preparation of CP1563 powder” on page 2 of Nakamura et al. Microbial Ecology in Health & Disease 2016, 27: 30312
*³Calculated value based on the mass of added flavor components

The results of Example 4 are shown in Table 8. It can be seen that the flavor improving effect by the predetermined amounts of nootkatone and linalool is also exhibited when not only acesulfame K used in Examples 1 to 3 but also other high-intensity sweeteners such as aspartame and sucralose are formulated.

TABLE 8

| | High-Intensity Sweetener | | | |
|---|---|---|---|---|
| | Aspartame | Sucralose | Acesulfame K | Average |
| Amount (w/w %) | 0.050 | 0.0167 | 0.050 | |
| Clean sensation*⁴ | 6.6 | 5.8 | 6.4 | 6.2 |
| (8: Have a | | | | |
| clean sensation) | | | | |
| Culture Medium | 1.8 | 2.6 | 1.8 | 2.2 |
| Odor*⁴ (0: No | | | | |
| culture medium odor) | | | | |

*⁴Score set to “4” for cases similar to the control product to which no flavor component is added, for each high-intensity sweetener

### Reference Example 1

A test beverage having the composition shown in Table 9 and formulated with a lactic acid bacterium powder, a (high-intensity) sweetener, an acidulant, nootkatone and linalool was prepared according to a conventional method. The formulated amount of the (high-intensity) sweetener was changed as shown in Table 10. Thereafter, a sensory test of flavor evaluation was conducted similarly as in Example 1.

TABLE 9

| Raw Material | Amount (w/w %) |
|---|---|
| (High-Intensity) Sweetener | See Table 10 |
| Citric Acid | 0.110 |
| Lactic Acid | 0.155 |
| Trisodium Citrate | 0.090 |
| Lactic Acid Bacterium Powder (CP1563 Strain | 0.050 |
| Crushed Lactic Acid Bacteria)*¹ | |
| Flavor Component*³ | See Table 10 |
| Properties | |
| Sugar Content | See Table 10 |
| Acidity | 0.22 |
| pH | 3.35 |
| Sweetness | 10.0 |

*¹Prepared according to “Preparation of CP1563 powder” on page 2 of Nakamura et al. Microbial Ecology in Health & Disease 2016, 27: 30312

The results of Reference Example 1 are shown in Table 10. When using granulated sugar (sucrose), which is a regular sweetener, instead of a high-intensity sweetener such as acesulfame K, the sugar content is high, and the culture medium odor is not much of a problem. Therefore, it is appropriate to position the action effect of the present invention as one for improving the problem of flavor such as the clean sensation and culture medium odor for a beverage containing lactic acid bacterium powder and a high-intensity sweetener.

TABLE 10

| | Control product | Level 1 | Level 2 | Level 3 | |
|---|---|---|---|---|---|
| | (High-Intensity) Sweetener | | | | |
| | | | Granulated | Granulated | |
| | Acesulfame K | Acesulfame K | Sugar | Sugar | Average |
| Amount (w/w %) | 0.050 | 0.050 | 10.000 | 10.000 | |
| Sugar Content | 0.40 | 0.40 | 10.0 | 10.0 | |
| Energy (kcal/100 ml) | 1.6 | 1.6 | 40 | 40 | |
| Flavor Component*³ | None | Nootkatone: 1000 ppb | None | Nootkatone: 1000 ppb | |
| | | Linalool: 250 ppb | | Linalool: 250 ppb | |
| Clean sensation*⁴ | 4.0 | 5.8 | 4.4 | 5.0 | 5.1 |
| (8: Have a clean | | | | | |
| sensation) | | | | | |
| Culture Medium | 4.0 | 2.6 | 2.0 | 1.6 | 2.1 |
| Odor*⁴ (0: No culture | | | | | |
| medium odor) | | | | | |

*³Calculated value based on the mass of added flavor components
*⁴Evaluation when the control product is set to “4”

1. A beverage comprising a lactic acid bacterium powder, a high-intensity sweetener, 10 to 5000 ppb of nootkatone and 2.5 to 2000 ppb of linalool.

2. The beverage according to claim 1, wherein the mass ratio of linalool and nootkatone is nootkatone/linalool=1 to 1000.

3. The beverage according to claim 1, wherein the lactic acid bacterium is cultured in a milk-free culture medium.

4. The beverage according to claim 1, wherein the lactic acid bacterium powder is comprised in an amount of 0.005 mass % or more and 0.5 mass % or less.

5. The beverage according to claim 1, wherein the lactic acid bacterium has a disrupted cell structure.

6. The beverage according to claim 1, wherein the high-intensity sweetener is one or more high-intensity sweeteners selected from acesulfame potassium, sucralose and aspartame.

7. The beverage according to claim 1, wherein the sugar content is 0.1 to 7.0 Bx.

8. The beverage according to claim 1, wherein the energy is 20 kcal/100 ml or less.

9. A method for producing a beverage, comprising a step of mixing a lactic acid bacterium powder, a high-intensity sweetener, 10 to 5000 ppb of nootkatone and 2.5 to 2000 ppb of linalool.

10. A method for improving the flavor of a beverage, comprising allowing the beverage to contain a lactic acid bacterium powder, a high-intensity sweetener, 10 to 5000 ppb of nootkatone and 2.5 to 2000 ppb of linalool together.

11. (canceled)
